(19) United States
(12) Patent Application Publication
(10) Pub. No.: US 2026/0307563 A1
(43) Pub. Date: Oct. 8, 2026

(54) VEHICLE SEATING ASSEMBLY HAVING INBOARD BOLSTER PORTIONS WITH DIFFERENT HARDNESS

(71) Applicant: Ford Global Technologies, LLC, Dearborn, MI (US)

(72) Inventors: Peter T. Mueller, Mount Clemens, MI (US); S. M. Akbar Berry, LaSalle (CA); Chris Fredriksson, LaSalle (CA); Johnathan Andrew Line, Northville, MI (US); Luis Antonio Morales, Metepec (MX); Todd A. Gagnier, Livonia, MI (US)

(73) Assignee: Ford Global Technologies, LLC, Dearborn, MI (US)

(21) Appl. No.: 19/169,359

(22) Filed: Apr. 3, 2025

(51) Int. Cl. B60N 2/64; B60N 2/427

(52) U.S. Cl. CPC B60N 2/646; B60N 2/42754

(57) ABSTRACT

A foam assembly of a vehicle seating assembly may be configured to cradle the user in the event of a force exerted against the vehicle seating assembly. The foam assembly may be configured to cradle the user as a function of the spatial relations between the foam assembly and the seatback frame. Additionally, the foam assembly may be configured to cradle the user as a function of an outboard fin and an inboard fin disposed within the foam assembly and a first set of ribs and a second set of ribs interposed between the foam assembly and the seatback frame. Further, the capacity of the foam assembly to cradle the user may be a function of the positioning of a structural wire of the foam assembly relative to a headrest aperture formed in an upper portion of the foam assembly.

### FIELD OF THE DISCLOSURE

The present disclosure generally relates to a vehicle seating assembly. Specifically, the present disclosure generally relates to the design modification of a foam assembly of a vehicle seating assembly, wherein the modified foam assembly facilitates the translation of the foam assembly to cradle a user of the vehicle seating assembly upon the exertion of a force against the seat foam assembly.

### BACKGROUND OF THE DISCLOSURE

Motor vehicles are commonly equipped with vehicle seating assemblies which typically include a seatback frame and foam assembly with bolsters. It would be desirable to provide for a seating assembly that allows enhanced performance characteristics while allowing for the vehicle seating assembly to react desirably to the exertion of an applied force against the vehicle seating assembly.

### SUMMARY OF THE DISCLOSURE

According to a first aspect of the present disclosure, a vehicle seating assembly comprises a seatback frame and a foam assembly coupled with the seatback frame, wherein the foam assembly comprises an outboard bolster portion, an inboard bolster portion, an upper portion extending between the outboard bolster portion and the inboard bolster portion, and a torso portion, wherein the inboard bolster portion comprises a first inboard portion and a second inboard portion, wherein the first inboard portion has a first firmness, and the second inboard portion has a second firmness, wherein the second firmness is greater than the first firmness.

Embodiments of the first aspect of the present disclosure can include any one or a combination of the following features:

The inboard bolster portion forms an inboard break interposed between the first inboard portion and the second inboard portion;

The vehicle seating assembly further comprises an inboard fin, wherein the inboard fin is interposed between the first inboard portion and the second inboard portion;

An inner surface of the first inboard portion forms a first chamfered surface;

The vehicle seating assembly further comprises a plurality of ribs interposed between the foam assembly and the seatback frame;

The vehicle seating assembly further comprises a first set of ribs disposed within a first front of seatback frame relief formed between an interior side of the torso portion and a first arm of the seatback frame;

The vehicle seating assembly further comprises an upper crossmember relief formed between an inner side of the upper portion and the seatback frame;

The inboard bolster portion further comprises a cross portion and a rear portion, wherein the cross portion extends from the second inboard portion and is coupled with the rear portion;

The inboard bolster portion further comprises a cross portion and a rear portion, wherein the cross portion extends from the second inboard portion and is coupled with the rear portion, wherein the rear portion, the cross portion, the first inboard portion, and the second inboard portion cooperate to define an inboard pocket relief;

The vehicle seating assembly further comprises a structural wire embedded within the foam assembly, wherein the structural wire extends through a section of the upper portion that is proximal to a rear of the vehicle relative to a headrest aperture formed by the upper portion;

The vehicle seating assembly further comprises a lumbar relief formed between an inner surface of the torso portion and a lower crossmember of the seatback frame; and

The seatback frame is substantially confined with the foam assembly.

According to a second aspect of the present disclosure, a vehicle seating assembly comprises a seatback frame and a foam assembly coupled with the seatback frame, comprising an outboard bolster portion, an inboard bolster portion, an upper portion extending between the outboard bolster portion and the inboard bolster portion, and a torso portion partially circumscribed by the outboard bolster portion, the inboard bolster portion, and the upper portion, wherein the foam assembly is configured to elastically deform under an exerted force, wherein the outboard bolster portion translates towards the inboard bolster portion, the inboard bolster portion translates towards the outboard bolster portion, and the torso portion translates towards a gap formed by the seatback frame.

Embodiments of the second aspect of the present disclosure can include any one or a combination of the following features:

The vehicle seating assembly further comprises a plurality of ribs interposed between the foam assembly and the seatback frame, wherein the plurality of ribs are configured to collapse when the torso portion translates towards the gap formed by the seatback frame under an exerted force;

The inboard bolster portion forms a first inboard portion and a second inboard portion, wherein the first inboard portion is configured to translate towards the seatback frame and the second inboard portion is configured to translate towards the outboard bolster portion, wherein the first inboard portion is configured to translate prior to the second inboard portion as a force is exerted against the vehicle seating assembly;

The foam assembly is configured to elastically deform from a first configuration to a second configuration, wherein in the second configuration, the foam assembly is adapted to cradle an occupant of the vehicle seating assembly; and

The vehicle seating assembly is configured to deform under an exerted force to translate an occupant of the vehicle seating assembly towards the gap formed by the seatback frame.

According to a third aspect of the present disclosure, a vehicle seating assembly comprises a seatback frame and a foam assembly coupled with the seatback frame comprising an inboard bolster portion formed of a first inboard portion and a second inboard portion, an outboard bolster portion formed of a first outboard portion and a second outboard portion, an upper portion extending between the outboard bolster portion and the inboard bolster portion, and a torso portion partially circumscribed by the outboard bolster portion, the inboard bolster portion, and the upper portion, wherein the foam assembly is configured to elastically deform from a first configuration to a second configuration, wherein in the second configuration the foam assembly is adapted to cradle an occupant of the vehicle seating assembly.

Embodiments of the third aspect of the present disclosure can include any one or combination of the following features:

The first inboard portion is configured to translate towards the seatback frame and the second inboard portion is configured to translate towards the outboard bolster portion, wherein the first inboard portion is configured to translate prior to the second inboard portion as a force is exerted against the vehicle seating assembly; and

The vehicle seating assembly further comprises a structural wire embedded within the foam assembly, wherein the structural wire extends through a section of the upper portion that is proximal to a rear of the vehicle relative to a headrest aperture.

These and other features, advantages, and objects of the present disclosure will be further understood and appreciated by those skilled in the art by reference to the following specification, claims, and appended drawings.

### BRIEF DESCRIPTION OF THE DRAWINGS

### In the drawings

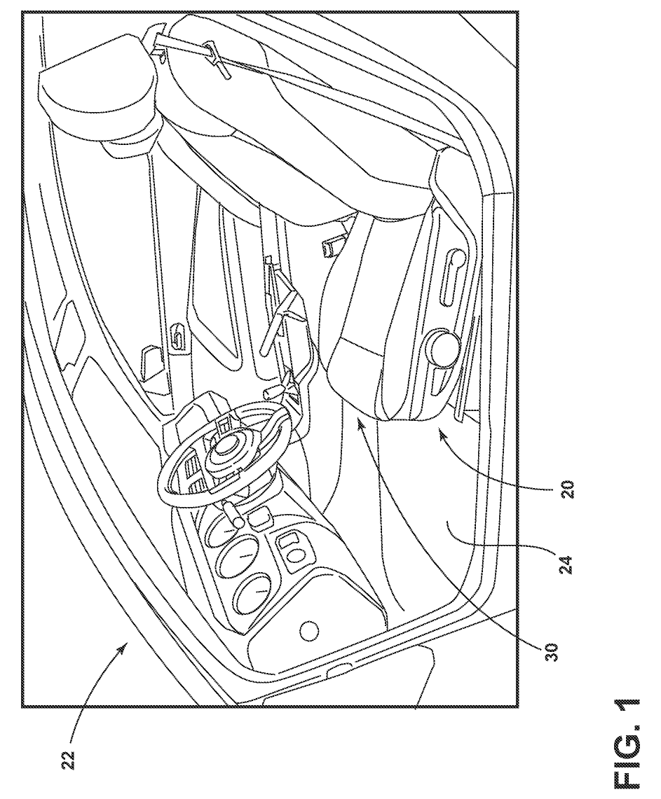

FIG. 1 is a side perspective view of a seating assembly within a passenger compartment of a vehicle.

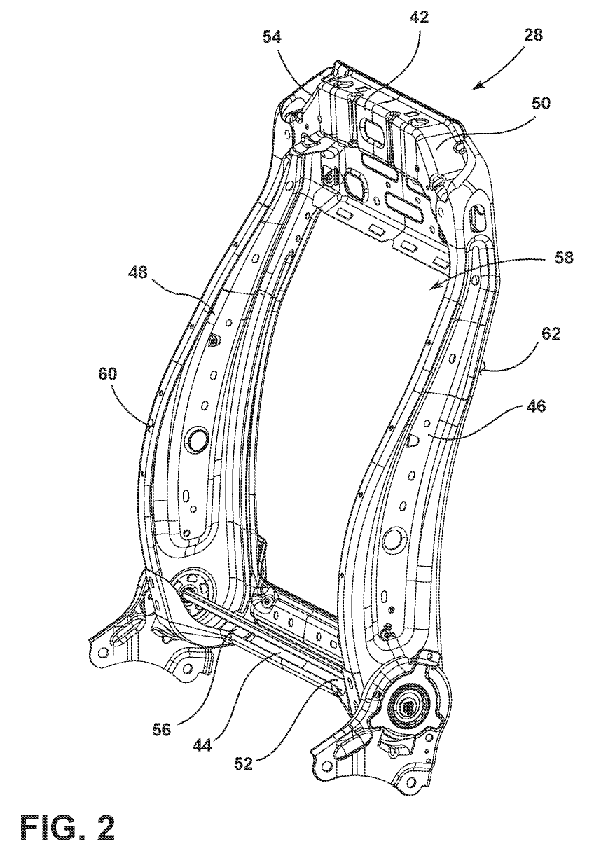

FIG. 2 is a top perspective view of a seatback frame of the seating assembly.

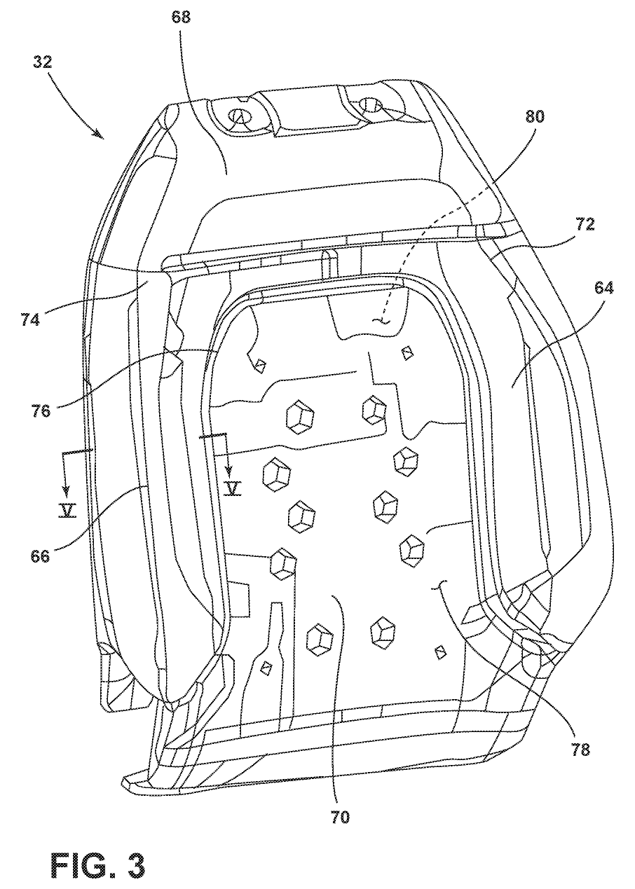

FIG. 3 is a top perspective view of the front of a foam assembly of the seating assembly.

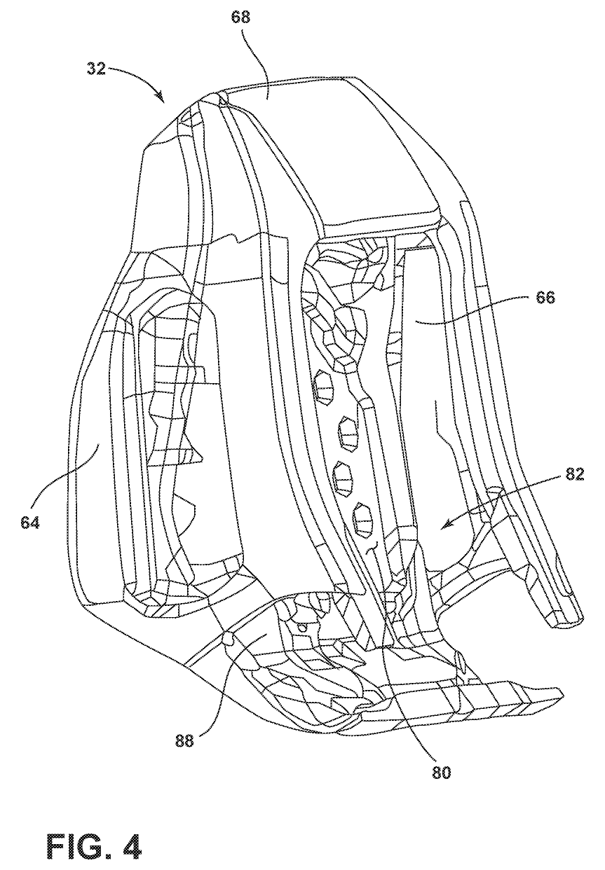

FIG. 4 is a top perspective view of the rear of a foam assembly of the seating assembly.

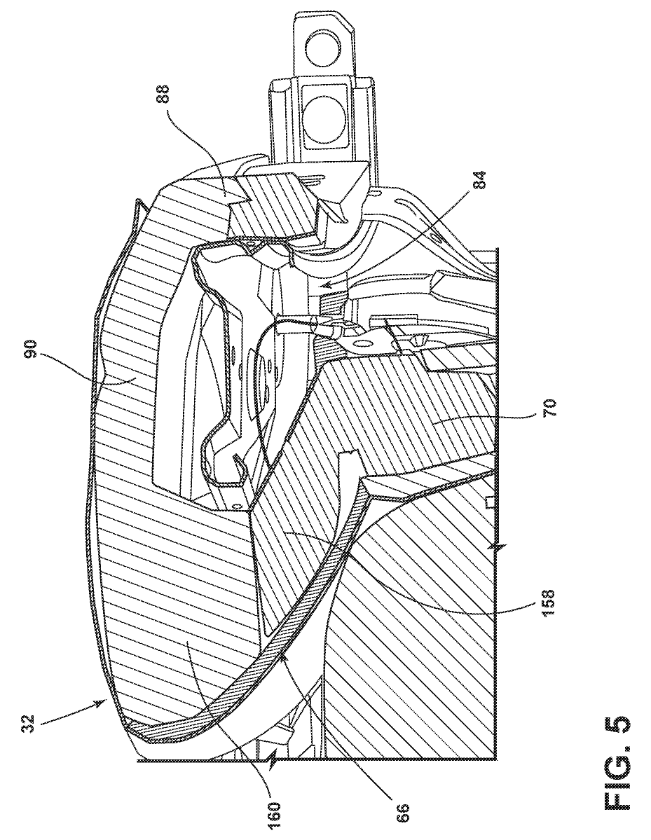

FIG. 5 is a cross-sectional view of the foam assembly taken at lines V in FIG. 3 showing an inboard pocket relief.

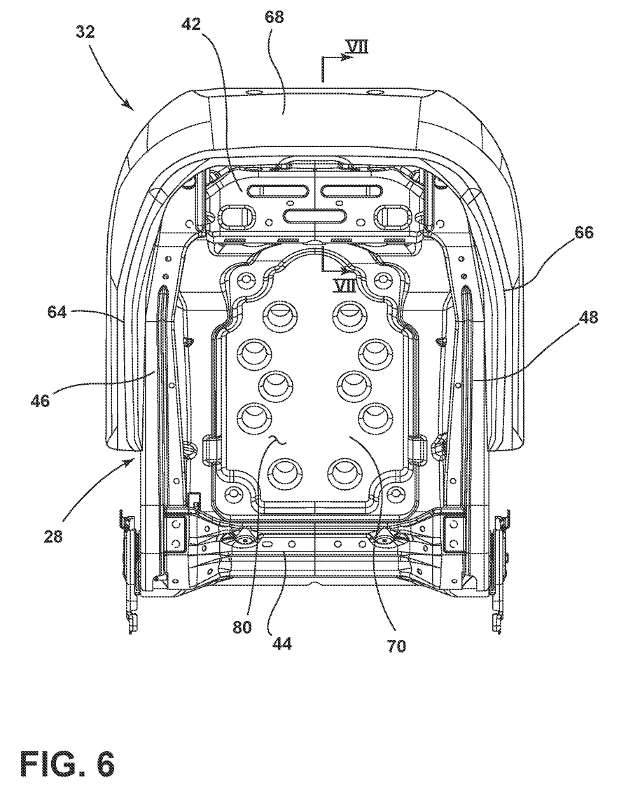

FIG. 6 is a rear elevational view of the foam assembly.

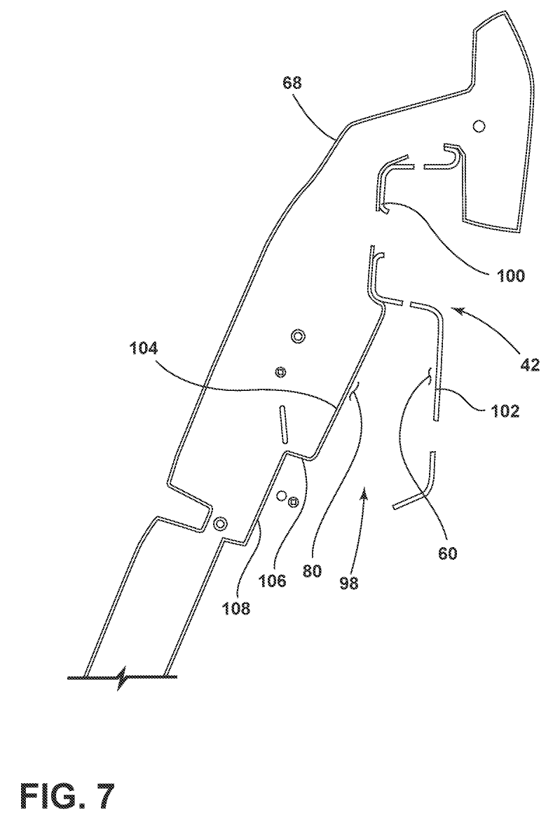

FIG. 7 is a cross-sectional view of the foam assembly taken at lines VII in FIG. 6 showing an upper crossmember relief.

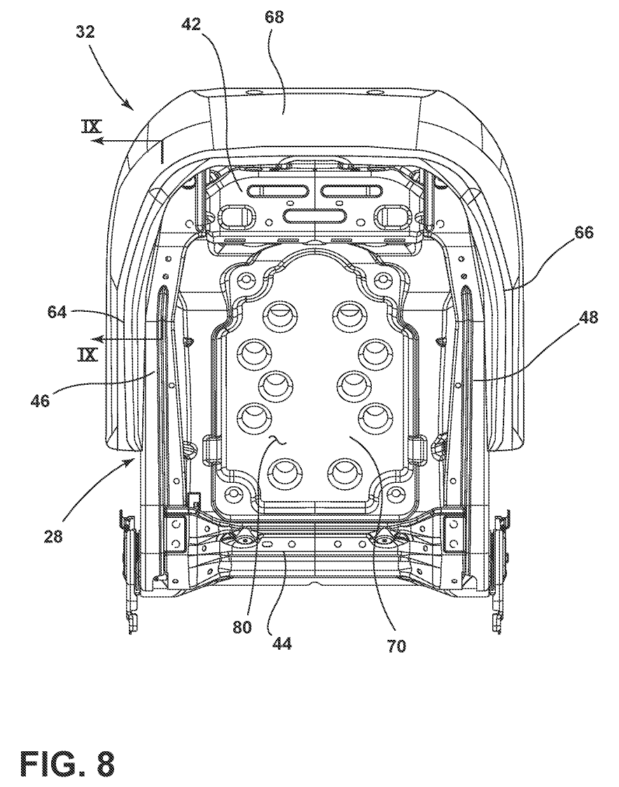

FIG. 8 is a rear elevational view of the foam assembly.

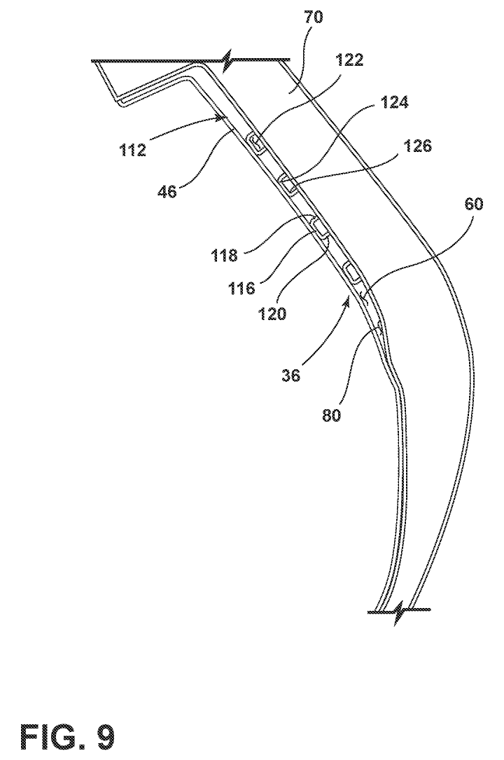

FIG. 9 is a cross-sectional view of the foam assembly taken at lines IX in FIG. 8 showing a first front of seatback relief.

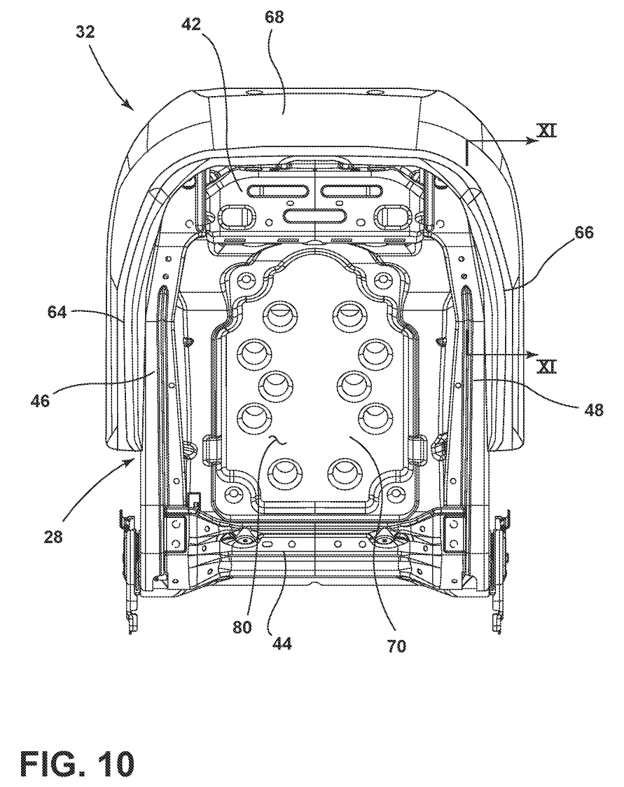

FIG. 10 is a rear elevational view of the foam assembly.

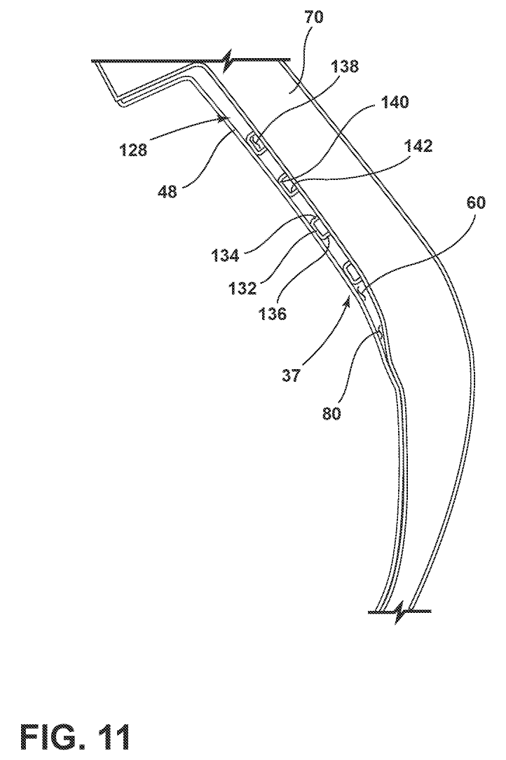

FIG. 11 is a cross-sectional view of the foam assembly taken at lines XI in FIG. 10 showing a second front of seatback relief.

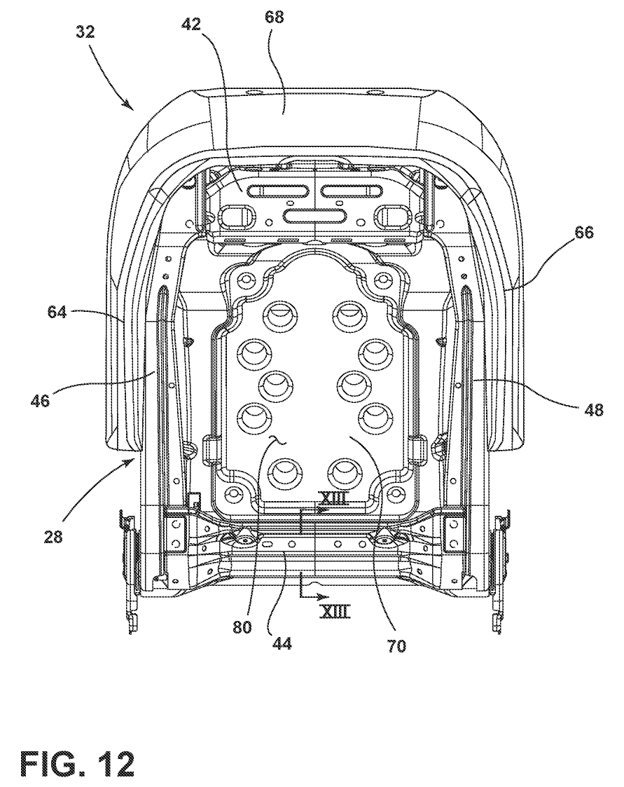

FIG. 12 is a rear elevational view of the foam assembly.

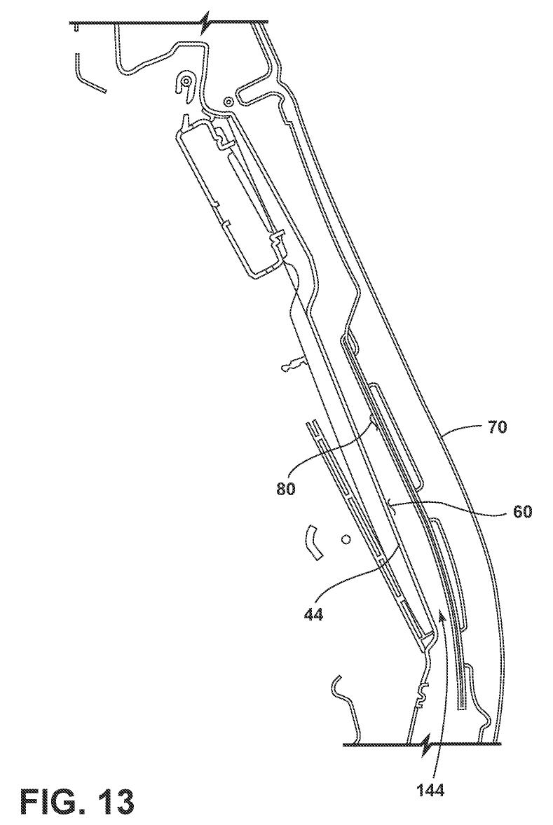

FIG. 13 is a cross-sectional view of the foam assembly taken at lines XIII in FIG. 12 showing a lumbar relief.

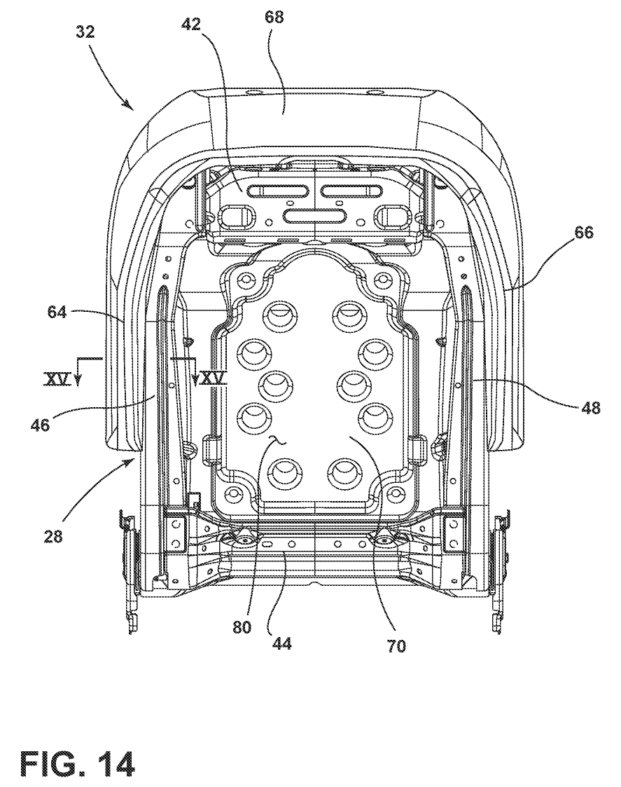

FIG. 14 is a rear elevational view of the foam assembly.

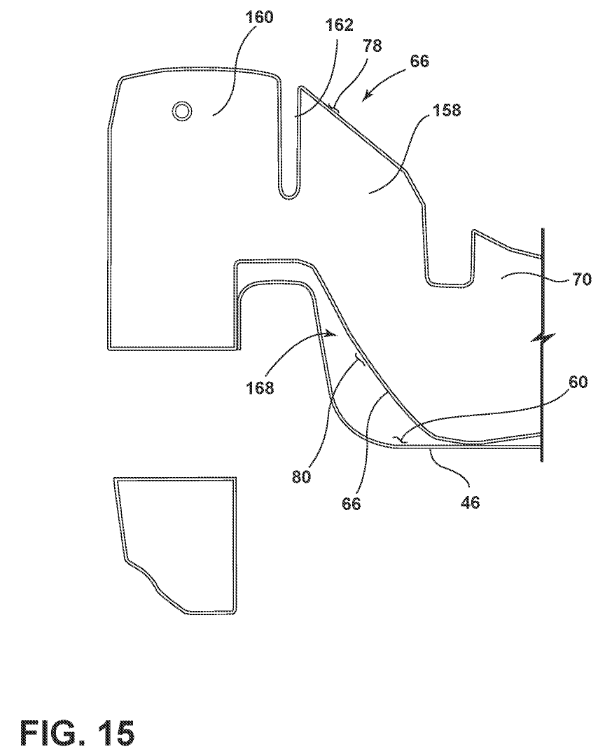

FIG. 15 is a cross-sectional view of the foam assembly taken at lines XV in FIG. 14 showing a first chamfer recess formed by a first chamfered surface of the foam assembly.

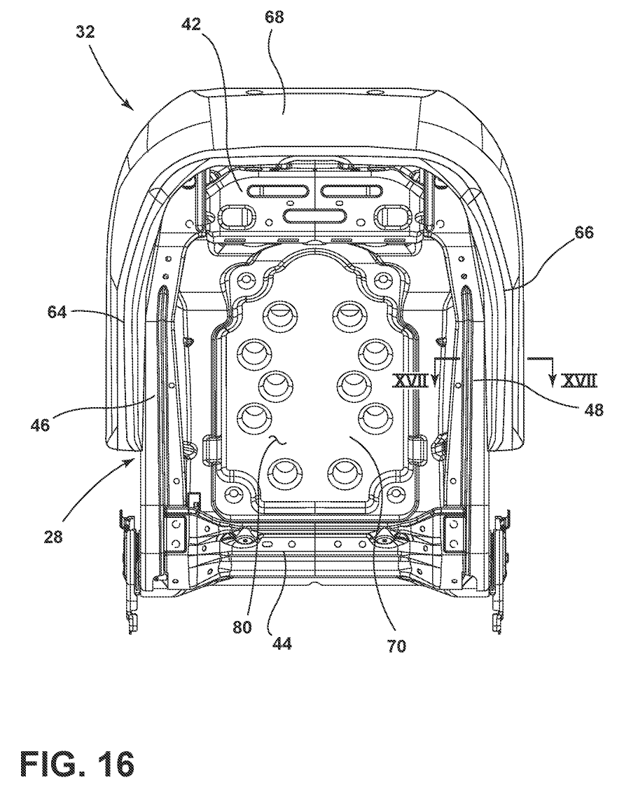

FIG. 16 is a rear elevational view of the foam assembly.

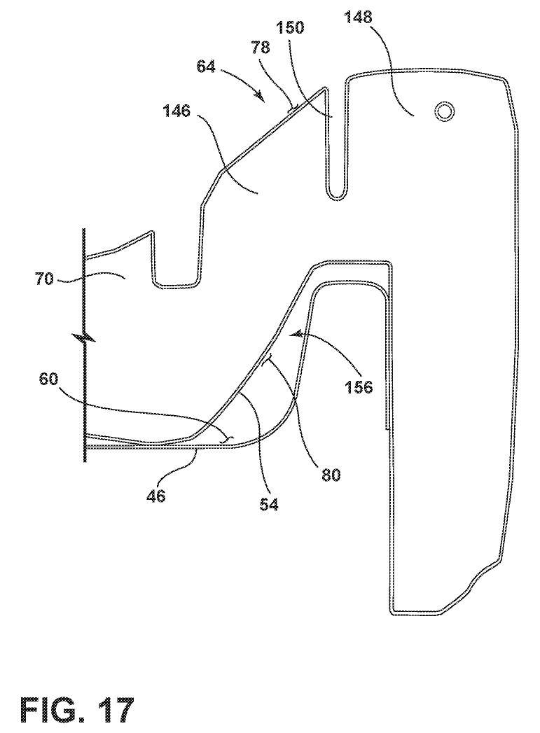

FIG. 17 is a cross-sectional view of the foam assembly taken at lines XVII in FIG. 16 showing a second chamfer recess formed by a second chamfered surface of the foam assembly.

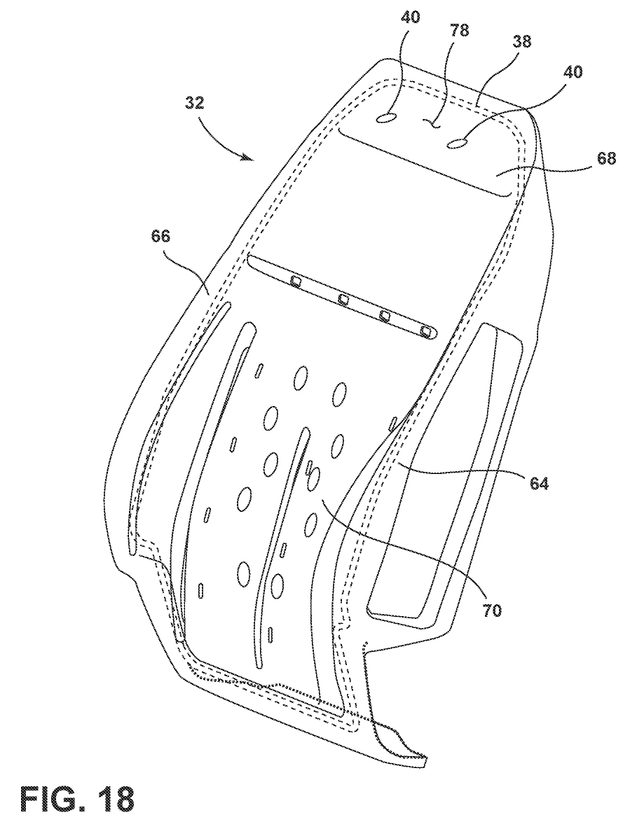

FIG. 18 is a top perspective view of the foam assembly showing a structural wire embedded within the foam assembly.

### DETAILED DESCRIPTION OF PREFERRED EMBODIENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle seating assembly, specifically to a foam assembly of a vehicle seating assembly, wherein the foam assembly is modified to facilitate the translation of the foam assembly to cradle a user of the vehicle seating assembly upon the exertion of a force against the vehicle seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-18, reference numeral 20 generally designates a vehicle seating assembly 20 for a vehicle 22. The vehicle seating assembly 20 is configured to be coupled to a floor 24 of the vehicle 22. The vehicle seating assembly 20 includes a support bracket and a seatback frame 28 that may be rotatably coupled to the support bracket. Additionally, the vehicle seating assembly 20 may include a headrest coupled with the seatback frame 28. Both the support bracket and the seatback frame 28 provide support for a user accommodation 30, configured to support a user of the vehicle 22. The user accommodation 30 includes a foam assembly 32 coupled to the seatback frame 28. The foam assembly 32 may be configured to cradle the user if a force is exerted against the vehicle seating assembly 20. The foam assembly 32 may be configured to cradle the user as a function of the spatial relations between the foam assembly 32 and the seatback frame 28. Additionally, the foam assembly 32 may be configured to cradle the user as a function of an outboard fin and an inboard fin disposed within the foam assembly 32 and a first set of ribs 36 and a second set of ribs 37 interposed between the foam assembly 32 and the seatback frame 28. Further, the capacity of the foam assembly 32 to cradle the user may be a function of the positioning of a structural wire 38 of the foam assembly 32 relative to a headrest aperture 40 formed in an upper portion 68 of the foam assembly 32.

Referring to FIG. 1, the vehicle seating assembly 20 may be positioned within the vehicle 22. For example, the vehicle seating assembly 20 may be positioned within a passenger compartment of the vehicle 22. The vehicle 22 may be a motor vehicle. For example, the vehicle 22 may be a land-based vehicle (e.g., an automobile, a motorcycle, a train, etc.), or an air-based vehicle (e.g., a plane or other aircraft). While the vehicle 22 may be a motor vehicle, the present disclosure is not limited to internal combustion engines as a source of locomotive power to the vehicle 22. For example, locomotive power may be provided to the vehicle 22 by electric motors, fuel cells, and/or petroleum-based fuel engines. According to various examples, a semi-autonomous example of the vehicle 22 may perform many, or all, commuting functions (e.g., braking, turning, signaling, etc.) independent of user interaction while the user maintains override control of the vehicle 22.

Referring to FIG. 2, the seatback frame 28 is formed of an upper crossmember 42, a lower crossmember 44, a first arm 46, and a second arm 48. The upper crossmember 42 and the lower crossmember 44 are connected via the first arm 46 that vertically extends from a first end 50 of the upper crossmember 42 to a first end 52 of the lower cross member 44. Additionally, the upper crossmember 42 and the lower crossmember 44 are connected via the second arm 48 that vertically extends from a second end 54 of the upper crossmember 42 to a second end 56 of the lower crossmember 44. As such, the upper crossmember 42, the lower crossmember 44, the first arm 46, and the second arm 48 cooperate to define a gap 58 of the seatback frame 28. The seatback frame 28 provides an outer surface 60 and an inner surface 62, wherein the outer surface 60 of the seatback frame 28 interfaces with and supports the foam assembly 32.

Referring to FIG. 3, the foam assembly 32 is formed of an outboard bolster portion 64, an inboard bolster portion 66, an upper portion 68, and a torso portion 70. The outboard bolster portion 64 and the inboard bolster portion 66 are connected via the upper portion 68 that laterally extends between a first end 72 of the outboard bolster portion 64 and a first end 74 of the inboard bolster portion 66. Further, the outboard bolster portion 64, the inboard bolster portion 66, and the upper portion 68 are interconnected via the torso portion 70 that is attached to an inner perimeter 76 defined by the outboard bolster portion 64, the inner bolster portion 66, and the upper portion 68. Together, the outboard bolster portion 64, the inboard bolster portion 66, the upper portion 68, and the torso portion 70 provide an outer surface 78 and an inner surface 80 that is referred to as a B-side. Each of the above components of the foam assembly 32 may be separate components that are joined to form the foam assembly 32, or alternatively, some, or all of the above-mentioned components may be integrally formed, such that the foam assembly 32 is a single unitary body.

With continued reference to FIG. 3, each component of the foam assembly 32 provides a degree of elasticity, such that each component may be deformed under an applied force and then resume a pre-deformation configuration upon the removal of the applied force. As such, the foam assembly 32 is elastically deformable.

With reference now to FIG. 4, the outboard bolster portion 64, the inboard bolster portion 66, the upper portion 68, and the torso portion 70 may define a B-side cavity 82. Specifically, the B-side cavity 82 may be defined by the inner surfaces 80 of the outboard bolster portion 64, the inboard bolster portion 66, and the torso portion 70. The foam assembly 32 is coupled with the seatback frame 28 such that the inner surface 80 of the foam assembly 32 interfaces with and is adjacent to the outer surface 60 of the seatback frame 28. Specifically, the seatback frame 28 may be disposed within the B-side cavity 82. As such, the upper cross member 42 of the seatback frame 28 may be disposed within a portion of the B-side cavity 82 formed by the upper portion 68 of the foam assembly 32. Further, the first arm 46 of the seatback frame 28 may be disposed within a portion of the B-side cavity 82 formed by the outboard bolster portion 64, and the second arm 48 may be disposed within a portion of the B-side cavity 82 formed by the inboard bolster portion 66. As such, substantially the entirety of the seatback frame 28 may be disposed within the B-side cavity 82 and surrounded by the foam assembly 32.

With reference now to FIGS. 4-18, the foam assembly 32 may be configured to translate relative to the seatback frame 28 to allow the foam assembly 32 to cradle the user upon the exertion of an applied force against the foam assembly 32. Specifically, the foam assembly 32 may form a plurality of reliefs disposed within the foam assembly 32 and/or positioned adjacent to the seatback frame 28 that allow the foam assembly 32 to translate relative to the seatback frame 28 such that the user is cradled by the foam assembly 32. Further, a plurality of structural components may be provided within and/or interposed between the foam assembly 32 and the seatback frame 28 to further allow for the foam assembly 32 to cradle the user upon the exertion of an applied force. Additionally, a structural wire 38, interposed within an interior of the foam assembly 32 may be positioned, relative to a plurality of headrest apertures 40 formed by the upper portion 68, such that the foam assembly 32 may cradle the user upon the exertion of an applied force.

Referring now to FIGS. 4 and 5, the inboard bolster portion 66 may form an inboard pocket relief 84. As shown in the illustrated embodiment, the inboard bolster portion 66 is formed of a first inboard portion 158, a second inboard portion 160, a rear portion 88, and a cross portion 90, that together cooperate to define the inboard pocket relief 84. The first inboard portion 158 extends from the torso portion 70, and the second inboard portion 160 extends from the first inboard portion 158, such that the first inboard portion 158 is interposed between the torso portion 70 and the second inboard portion 160. The cross portion 90 is coupled with and laterally extends between the second inboard portion 160 and the rear portion 88. The first inboard portion 158, the second inboard portion 160, the rear portion 88, and the cross portion 90 together cooperate to define the inboard pocket relief 84, providing a hollow interior to the inboard bolster portion 66. Additionally, the inboard pocket relief 84 may have a substantially oval-like shape as shown in the example illustrated in FIG. 5. In such a configuration, a major axis of the inboard pocket relief 84 may vertically extend substantially towards the upper portion 68 and substantially towards the floor 24 of the vehicle 22. A minor axis of the inboard pocket relief 84 may extend substantially towards the cross portion 90 and substantially towards the torso portion 70.

Referring still to FIGS. 4 and 5, the first inboard portion 158, the second inboard portion 160, the rear portion 88, and the cross portion 90 may each be individual components coupled together to form the inboard bolster portion 66 and define the inboard pocket relief 84. Alternatively, two or more of the above-mentioned components may be integrally formed, such that the inboard bolster portion 66 is a single unitary body or is formed of components that are integrally formed and define single unitary bodies.

Referring now to FIG. 6-7, the foam assembly 32 may define an upper crossmember relief 98. The upper crossmember relief 98 may be formed by the foam assembly 32 at the portion of the foam assembly 32 adjacent to the upper crossmember 42. As such, the upper crossmember relief 98 is positioned adjacent to the outer surface 60 of the upper crossmember 42 of the seatback frame 28. The upper crossmember relief 98 may be formed by the upper portion 68 of the foam assembly 32, specifically, via the inner surface 80 of the upper portion 68 of the foam assembly 32. Moreover, the upper crossmember relief 98 may be defined between the inner surface 80 of the upper portion 68 of the foam assembly 32 and the outer surface 60 of the upper crossmember 42 of the seatback frame 28. As such, the upper crossmember relief 98 provides a gap between the inner surface 80 of the foam assembly 32 and the outer surface 60 of the upper crossmember 42.

With continued reference to FIGS. 6-7, the upper crossmember 42 may be formed of a top panel 100 and a bottom panel 102 as shown in the illustrated example of FIG. 6-7. The bottom panel 102 may be positioned inferior to the top panel 100 and the bottom panel 102 may be formed proximal to the rear of the vehicle 22 relative to the top panel 100. As such, the bottom panel 102 may be closer to the floor 24 and to the rear of the vehicle 22 than the top panel 100. The upper crossmember relief 98 may be specifically formed between the inner surface 80 of the upper portion 68 of the foam assembly 32 and the outer surface 60 of the bottom panel 102. As such, the upper crossmember relief 98 may have a substantially rectangular shape that is substantially proportionate to the dimensions of the bottom panel 102.

With reference to FIG. 7, the portion of the inner surface 80 of the upper portion 68 that partially defines the upper crossmember relief 98 may form a first surface 104, an overhang 106, and a second surface 108. The first surface 104 may extend at an angle relative to the bottom panel 102 and define a substantially planar surface. Likewise, the second surface 108 may extend at an angle relative to the bottom panel 102 and define a substantially planar surface. The second surface 108 may be positioned inferior to the first surface 104. Additionally, the second surface 108 may be offset from the first surface 104, such that the first surface 104 is positioned proximal to the bottom panel 102, relative to the second surface 108. As such, the first surface 104 is positioned above the second surface 108 and is positioned closer to the bottom panel 102 than the second surface 108. The overhang 106 extends substantially perpendicular relative to the first surface 104 and the second surface 108 and connects the first surface 104 and the second surface 108.

Referring now to FIGS. 8 and 9, the foam assembly 32 may define a first front of seatback relief 112. The first front of seatback relief 112 may be formed by the foam assembly 32 adjacent to the outer surface 60 of the first arm 46 of the seatback frame 28. As such, the first front of seatback relief 112 is positioned adjacent to the outer surface 60 of the first arm 46 of the seatback frame 28. The first front of seatback relief 112 may be formed by the torso portion 70, specifically, via the portion of the inner surface 80 of the torso portion 70 that is adjacent to the outer surface 60 of the first arm 46. Additionally, the first front of seatback relief 112 may be formed by the outboard bolster portion 64, specifically, via the portion of the inner surface 80 of the outboard bolster portion 64 that is adjacent to the outer surface 60 of the first arm 46. Further, the first front of seatback relief 112 may be formed by both the torso portion 70 and the outboard bolster portion 64, specifically, via the inner surfaces 80 of both the torso portion 70 and the outboard bolster portion 64.

Referring still to FIGS. 8 and 9, the first front of seatback relief 112 may provide a gap between the inner surface 80 of the foam assembly 32 and the outer surface 60 of the first arm 46 of the seatback. The gap may define a distance extending between the inner surface 80 of the foam assembly 32 and the outer surface 60 of the first arm 46 of about 8 mm to about 12 mm, for example. The first front of seatback relief 112 may extend a substantial majority of the length of the inner surface 80 of the foam assembly 32 adjacent to the outer surface 60 of the first arm 46. Alternatively, the first front of seatback relief 112 may extend only partially the length of the inner surface 80 of the foam assembly 32 adjacent to the outer surface 60 of the first arm 46. Accordingly, at least a portion of the inner surface 80 of the foam assembly 32 is spaced from the outer surface 60 of the first arm 46 by about 8 mm to about 12 mm according to this example.

Still referring to FIGS. 8 and 9, a first set of ribs 36 may be interposed between the inner surface 80 of the foam assembly 32 and the outer surface 60 of the first arm 46. Specifically, the first set of ribs 36 may be positioned within the first front of seatback relief 112. The first set of ribs 36 may include a plurality of ribs. Alternatively, the first set of ribs 36 may include a single rib. Each rib of the first set of ribs 36 may function as a structural support, providing support to the foam assembly 32 against the first arm 46 of the seatback frame 28. Further, each rib may be formed of a base 116, a first leg 118, and a second leg 120. The base 116 of each rib forms a substantially planar rib surface 122 that laterally and longitudinally extends across the outer surface 60 of the first arm 46 and forms a substantially rectangular shape. As such, a major axis of each rib extends substantially towards the outboard bolster portion 64 and substantially towards the inboard bolster portion 66, and a minor axis of each rib extends substantially towards the upper crossmember 42 and substantially towards the lower crossmember 44. The first leg 118 may vertically extend substantially perpendicular to the rib surface 122 towards the inner surface 80 of the foam assembly 32. The first leg 118 may be positioned adjacent to and extend along substantially the entirety of a first edge 124 of the rib surface 122. The second leg 120 may be positioned adjacent to and extend along substantially the entirety of a second edge 126 of the rib surface 122, wherein the second edge 126 is disposed opposite the first edge 124. Further, the first edge 124 may be disposed superior to the second edge 126, such that the first edge 124 is closer to the upper portion 68 of the foam assembly 32 than the second edge 126. Additionally, the first edge 124 and the second edge 126 may extend substantially parallel to the major axis of each rib.

With continued reference to FIGS. 8 and 9, the first leg 118 and the second leg 120 of each rib may define a distance therebetween of about 12mm to about 18mm in one example. Further, when the first set of ribs 36 includes more than one rib, each rib may be longitudinally spaced apart, wherein a distance between each rib of the first set of ribs 36 may be about 20mm to about 30mm.

Now referring to FIGS. 10 and 11, the foam assembly 32 may define a second front of seatback relief 128. The second front of seatback relief 128 may be formed by the foam assembly 32 adjacent to the outer surface 60 of the second arm 48 of the seatback frame 28. As such, the second front of seatback relief 128 is positioned adjacent to the outer surface 60 of the second arm 48 of the seatback frame 28. The second front of seatback relief 128 may be formed by the torso portion 70, specifically, via the portion of the inner surface 80 of the torso portion 70 that is adjacent to the outer surface 60 of the second arm 48. Additionally, the second front of seatback relief 128 may be formed by the inboard bolster portion 66, specifically, via the portion of the inner surface 80 of the inboard bolster portion 66 that is adjacent to the outer surface 60 of the second arm 48. Further, the second front of seatback relief 128 may be formed by both the torso portion 70 and the inboard bolster portion 66, specifically, via the inner surfaces 80 of both the torso portion 70 and the inboard bolster portion 66.

With continued reference to FIGS. 10 and 11, the second front of seatback relief 128 may provide a gap between the inner surface 80 of the foam assembly 32 and the outer surface 60 of the second arm 48 of the seatback frame 28. The gap may define a distance extending between the inner surface 80 of the foam assembly 32 and the outer surface 60 of the second arm 48 of about 8 mm to about 12 mm, for example. The second front of seatback relief 128 may extend a substantial majority of the length of the inner surface 80 of the foam assembly 32 adjacent to the outer surface 60 of the second arm 48. Alternatively, the second front of seatback relief 128 may extend only partially the length of the inner surface 80 of the foam assembly 32 adjacent to the outer surface 60 of the second arm 48. Accordingly, at least a portion of the inner surface 80 of the foam assembly 32 is spaced from the outer surface 60 of the second arm 48 by about 8 mm to about 12 mm in this example.

Referring still to FIGS. 10 and 11, a second set of ribs 37 may be interposed between the inner surface 80 of the foam assembly 32 and the outer surface 60 of the second arm 48. Specifically, the second set of ribs 37 may be positioned within the second front of seatback relief 128. The second set of ribs 37 may include a plurality of ribs. Alternatively, the second set of ribs 37 may include a single rib. Each rib of the second set of ribs 37 may function as a structural support, providing support to the foam assembly 32 against the second arm 48 of the seatback frame 28. Further, each rib may be formed of a base 132, a first leg 134, and a second leg 136. The base 132 of each rib forms a substantially planar rib surface 138 that laterally and longitudinally extends across the outer surface 60 of the second arm 48 and forms a substantially rectangular shape. As such, a major axis of each rib extends substantially towards the outboard bolster portion 64 and substantially towards the inboard bolster portion 66, and a minor axis of each rib extends substantially towards the upper crossmember 42 and substantially towards the lower crossmember 44. The first leg 134 may vertically extend substantially perpendicular to the rib surface 138 towards the inner surface 80 of the foam assembly 32. The first leg 134 may be positioned adjacent to and extend along substantially the entirety of a first edge 140 of the rib surface 138. The second leg 136 may be positioned adjacent to and extend along substantially the entirety of a second edge 142 of the rib surface 138, wherein the second edge 142 is disposed opposite the first edge 140. Further, the first edge 140 may be disposed superior to the second edge 142, such that the first edge 140 is closer to the upper portion 68 of the foam assembly 32 than the second edge 142. Additionally, the first edge 140 and the second edge 142 may extend substantially parallel to the major axis of each rib.

With continued reference to FIGS. 10 and 11, the first leg 134 and the second leg 136 of each rib of the second set of ribs 37 may define a distance therebetween of about 12mm to about 18mm, for example. Further, when the second set of ribs 37 includes more than one rib, each rib may be longitudinally spaced apart, wherein a distance between each rib of the second set of ribs 37 may be about 20mm to about 30mm.

Referring now to FIGS. 12 and 13, the foam assembly 32 may define a lumbar relief 144. The lumbar relief 144 may be formed by the foam assembly 32 adjacent to the outer surface 60 of the lower crossmember 44. As such, the lumbar relief 144 is positioned adjacent to the outer surface 60 of the lower crossmember 44. The lumbar relief 144 may be formed by the torso portion 70, specifically, via the portion of the inner surface 80 of the torso portion 70 that is adjacent to the outer surface 60 of the lower crossmember 44. The lumbar relief 144 may provide a gap between the inner surface 80 of the foam assembly 32 and the outer surface 60 of the lower crossmember 44. The gap may define a distance extending between the inner surface 80 of the foam assembly 32 and the outer surface 60 of the lower crossmember 44 of about 12mm to about 18mm.

Referring now to FIGS. 14 and 15, the outboard bolster portion 64 may be formed of a first outboard portion 146 and a second outboard portion 148. The first outboard portion 146 may be adjacent to and extend from the torso portion 70 of the foam assembly 32. The second outboard portion 148 may be adjacent to and extend from the first outboard portion 146. As such, the first outboard portion 146 may be interposed between the torso portion 70 and the second outboard portion 148. The first outboard portion 146 and the second outboard portion 148 may be separate components coupled together to form the outboard portion. Alternatively, the first outboard portion 146 and the second outboard portion 148 may be integrally formed, such that the outboard bolster portion 64 is formed of a single unitary body.

With continued reference to FIGS. 14 and 15, the first outboard portion 146 may have a first firmness and the second outboard portion 148 may have a second firmness. The second firmness provided by the second outboard portion 148 may be greater than the first firmness provided by the first outboard portion 146. As such, the first outboard portion 146 provides less resistance to a force applied against the outboard bolster portion 64, relative to the second outboard portion 148. Moreover, the first outboard portion 146 is configured to elastically deform prior in time, relative to the second outboard portion 148, as a force is applied incrementally against the outboard bolster portion 64. Consequently, when a force is applied against the outboard bolster portion 64, the outboard bolster portion 64 deforms at the first outboard portion 146 before deforming at the second outboard portion 148. Additionally, the outboard bolster portion 64 may deform about an outboard deformation axis longitudinally extending between the first outboard portion 146 and the second outboard portion 148, causing the second outboard portion 148 to translate substantially laterally towards the centerline of the foam assembly 32, as the outboard bolster portion 64 is deformed or bent at the outboard deformation axis. As such, upon the exertion of a force against the outboard bolster portion 64, the outboard bolster portion 64 deforms at the outboard deformation axis and the second outboard portion 148 is moved towards the user to effectuate a cradling of the user by the foam assembly 32.

Still referring to FIGS. 14 and 15, an outboard break 150 may be formed between the first outboard portion 146 and the second outboard portion 148 of the outboard bolster portion 64. The outboard break 150 may extend from the outer surface 78 of the outboard bolster portion 64 into the interior of the outboard bolster portion 64, forming a gap that extends substantially the entire height of the outboard bolster portion 64. Further, the outboard break 150 may extend substantially perpendicular to the outer surface 78 of the outboard bolster portion 64. The outboard break 150 may additionally form a substantially triangular cross-section. The outboard break 150 may be configured to facilitate the translation of the second outboard portion 148 towards the user, generally facilitating the cradling of the user by the foam assembly 32 under an applied force. As such, the outboard break 150 may be aligned with the outboard deformation axis, such that the outboard bolster portion 64 may deform about the outboard break 150 under an applied force.

With continued reference to FIGS. 14 and 15, an outboard fin may be interposed between the first outboard portion 146 and the second outboard portion 148 of the outboard bolster portion 64. The outboard fin may form a substantially planar body and extend from the outer surface 78 of the outboard bolster portion 64 into the interior of the outboard bolster portion 64. Further, the outboard fin may longitudinally extend at least a portion of the height of the outboard bolster portion 64. Additionally, the outboard fin may be disposed within the outboard break 150. The outboard fin functions to further separate the first outboard portion 146 and the second outboard portion 148, facilitating the deformation of the first outboard portion 146 and the resulting translation of the second outboard portion 148 towards the user as a force is applied to the foam assembly 32.

With continued reference to FIGS. 14 and 15, the inner surface 80 of the first outboard portion 146 may form a first chamfered surface 154. Alternatively, the first chamfered surface 154 may be formed together by the inner surface 80 of the torso portion 70 and the inner surface 80 of the first outboard portion 146. The first chamfered surface 154 may extend substantially the entire height of the first outboard portion 146 or, alternatively, substantially the entire height of the torso portion 70 when the first chamfered surface 154 is partially formed by the torso portion 70. Further, the first chamfered surface 154 may be positioned adjacent to and spaced from the first arm 46 of the seatback frame 28. As such, a first chamfer recess 156 may be defined between the first chamfered surface 154 and the outer surface 60 of the first arm 46. The first chamfered surface 154 is configured to facilitate the translation of the first outboard portion 146 across the first chamfer recess 156 towards the outer surface 60 of the first arm 46, as the outboard bolster portion 64 is deformed. Consequently, the first chamfered surface 154 facilitates the translation of the second outboard portion 148 towards the user under an applied force.

Referring now to FIGS. 16 and 17, the inboard bolster portion 66 may be formed of the first inboard portion 158 and the second inboard portion 160. The first inboard portion 158 may be adjacent to and extend from the torso portion 70 of the foam assembly 32. The second inboard portion 160 may be adjacent to and extend from the first inboard portion 158. As such, the first inboard portion 158 may be interposed between the torso portion 70 and the second inboard portion 160. The first inboard portion 158 and the second inboard portion 160 may be separate components coupled together to form the inboard bolster portion 66. Alternatively, the first inboard portion 158 and the second inboard portion 160 may be integrally formed, such that the inboard bolster portion 66 is formed of a single unitary body.

With continued reference to FIGS. 16 and 17, the first inboard portion 158 may have a first firmness and the second inboard portion 160 may have a second firmness. The second firmness provided by the second inboard portion 160 may be greater than the first firmness provided by the first inboard portion 158. As such, the first inboard portion 158 provides less resistance to a force applied against the inboard bolster portion 66, relative to the second inboard portion 160. Moreover, the first inboard portion 158 is configured to elastically deform prior in time, relative to the second inboard portion 160, as a force is applied incrementally against the inboard bolster portion 66. Consequently, when a force is applied against the inboard bolster portion 66, the inboard bolster portion 66 deforms at the first inboard portion 158 before deforming at the second inboard portion 160. Additionally, the inboard bolster portion 66 may deform about an inboard deformation axis longitudinally extending between the first inboard portion 158 and the second inboard portion 160, causing the second inboard portion 160 to translate substantially laterally towards the centerline of the foam assembly 32, as the inboard bolster portion 66 is deformed, or bent, at the inboard deformation axis. As such, upon the exertion of a force against the inboard bolster portion 66, the inboard bolster portion 66 deforms at the inboard deformation axis and the second inboard portion 160 is moved towards the user to effectuate a cradling of the user by the foam assembly 32.

Still referring to FIGS. 16 and 17, an inboard break 162 may be formed between the first inboard portion 158 and the second inboard portion 160. The inboard break 162 may extend from the outer surface 78 of the inboard bolster portion 66 into the interior of the inboard bolster portion 66, forming a gap that extends substantially the entire height of the inboard bolster portion 66. Further, the inboard break 162 may extend substantially perpendicular to the outer surface 78 of the inboard bolster portion 66. The inboard break 162 may additionally form a substantially triangular cross-section. The inboard break 162 may be configured to facilitate the translation of the second inboard portion 160 towards the user, generally facilitating the cradling of the user by the foam assembly 32 under an applied force. As such, the inboard break 162 may be aligned with the inboard deformation axis, such that the inboard bolster portion 66 may deform about the inboard break 162 under an applied force.

With reference still to FIGS. 16 and 17, an inboard fin may be interposed between the first inboard portion 158 and the second inboard portion 160. The inboard fin may form a substantially planar body and extend from the outer surface 78 of the inboard bolster portion 66 into the interior of the inboard bolster portion 66. Further, the inboard fin may longitudinally extend at least a portion of the height of the inboard bolster portion 66. Additionally, the inboard fin may be disposed within the inboard break 162. The inboard fin functions to further separate the first inboard portion 158 and the second inboard portion 160, facilitating the translation of the second inboard portion 160 towards the user as a force is applied to the foam assembly 32.

With continued reference to FIGS. 16 and 17, the inner surface 80 of the first inboard portion 158 may form a second chamfered surface 166. Alternatively, the second chamfered surface 166 may be formed together by the inner surface 80 of the torso portion 70 and the inner surface 80 of the first inboard portion 158. The second chamfered surface 166 may extend substantially the entire height of the first inboard portion 158 or, alternatively, substantially the entire height of the torso portion 70 when the second chamfered surface 166 is partially formed by the torso portion 70. Further, the second chamfered surface 166 may be positioned adjacent to and spaced from the second arm 48 of the seatback frame 28. As such, a second chamfer recess 168 may be defined between the second chamfered surface 166 and the outer surface 60 of the second arm 48. The second chamfered surface 166 is configured to facilitate the translation of the first inboard portion 158 towards the outer surface 60 of the second arm 48, as the inboard bolster portion 66 is deformed. Consequently, the second chamfered surface 166 facilitates the translation of the second inboard portion 160 towards the user under an applied force.

With reference now to FIG. 18, the structural wire 38 may be embedded within the interior of the foam assembly 32. The structural wire 38 may extend throughout the interior of the foam assembly 32 and conform substantially to the shape formed by the foam assembly 32. Specifically, the structural wire 38 may extend through a section of the upper portion 68 that is proximal to the rear of the vehicle 22 relative to each of a plurality of headrest apertures 40 that are formed by the outer surface 78 of the upper portion 68. Consequently, a headrest of the vehicle seating assembly 20, mounted to the upper portion 68 via the plurality of headrest apertures 40, will be positioned closer to the user of the seating assembly than the structural wire 38.

In operation, each of the above-detailed features of the foam assembly 32 cooperate to facilitate the transition of the foam assembly 32 from a first configuration to a second configuration. In the first configuration, the foam assembly 32 is undeformed and is positioned to receive the user. In the second configuration, the foam assembly 32 is deformed, such that the foam assembly 32 substantially cradles the user. Specifically, under the applied force the outboard bolster portion 64 and the inboard bolster portion 66 both deform about the respective deformation axis, such that the second outboard portion 148 and second inboard portion 160 are translated towards the user. As the inboard bolster portion 66 and the outboard bolster portion 64 deform, the first inboard portion 158 and the first outboard portion 146 are translated towards the seatback frame 28, and the second outboard portion 148 and the second inboard portion 160 are consequently translated towards the user. As such, each of the bolster portions 64, 66 substantially curl inwards towards the centerline of the foam assembly, and approximately towards the user upon an exerted force. Further, as the bolster portions curl towards the user, the torso portion 70 translates towards the gap 58 formed by the seatback frame 28. Consequently, both sets of ribs 36, 37 are crushed, and each of the abovementioned reliefs are traversed by the inner surface 80 of the foam assembly 32 as the torso portion 70 translates towards the gap 58 formed by the seatback frame 28.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly, comprising:
a seatback frame; and
a foam assembly coupled with the seatback frame, comprising:
an outboard bolster portion;
an inboard bolster portion, comprising a first inboard portion and a second inboard portion, wherein the first inboard portion has a first firmness, and the second inboard portion has a second firmness, wherein the second firmness is greater than the first firmness;
an upper portion extending between the outboard bolster portion and the inboard
bolster portion; and
a torso portion.

2. The vehicle seating assembly of claim 1, wherein the inboard bolster portion forms an inboard break interposed between the first inboard portion and the second inboard portion.

3. The vehicle seating assembly of claim 1, further comprising an inboard fin, wherein the inboard fin is interposed between the first inboard portion and the second inboard portion.

4. The vehicle seating assembly of claim 1, wherein an inner surface of the first inboard portion forms a first chamfered surface.

5. The vehicle seating assembly of claim 1, further comprising a plurality of ribs interposed between the foam assembly and the seatback frame.

6. The vehicle seating assembly of claim 5, wherein a first set of ribs of the plurality of ribs are disposed within a first front of seatback frame relief formed between an interior side of the torso portion and a first arm of the seatback frame.

7. The vehicle seating assembly of claim 1, wherein an upper crossmember relief is formed between an inner side of the upper portion and the seatback frame.

8. The vehicle seating assembly of claim 1, wherein the inboard bolster portion further comprises a cross portion and a rear portion, wherein the cross portion laterally extends from the second inboard portion and is coupled with the rear portion.

9. The vehicle seating assembly of claim 8, wherein the rear portion, the cross portion, the first inboard portion, and the second inboard portion cooperate to define an inboard pocket relief.

10. The vehicle seating assembly of claim 1, further comprising a structural wire embedded within the foam assembly, wherein the structural wire extends through a section of the upper portion that is proximal to a rear of the vehicle relative to a headrest aperture formed by the upper portion.

11. The vehicle seating assembly of claim 1, where a lumbar relief is formed between an inner surface of the torso portion and a lower crossmember of the seatback frame.

12. The vehicle seating assembly of claim 1, wherein the seatback frame is substantially confined within the foam assembly.

13. A vehicle seating assembly, comprising:
a seatback frame; and
a foam assembly coupled with the seatback frame, comprising:
an outboard bolster portion;
an inboard bolster portion;
an upper portion extending between the outboard bolster portion and the inboard bolster portion; and
a torso portion partially circumscribed by the outboard bolster portion, the inboard bolster portion, and the upper bolster portion, wherein the foam assembly is configured to elastically deform under an exerted force, wherein:
the outboard bolster portion translates towards the inboard bolster portion;
the inboard bolster portion translates towards the outboard bolster portion; and
the torso portion translates towards a gap formed by the seatback frame.

14. The vehicle seating assembly of claim 13, further comprising a plurality of ribs interposed between the foam assembly and the seatback frame, wherein the plurality of ribs are configured to collapse when the torso portion translates towards the gap formed by the seatback frame under an exerted force.

15. The vehicle seating assembly of claim 13, wherein the inboard bolster portion forms a first inboard portion and a second inboard portion, wherein the first inboard portion is configured to translate towards the seatback frame and the second inboard portion is configured to translate towards the outboard bolster portion, wherein the first inboard portion is configured to translate prior to the second inboard portion as a force is exerted against the vehicle seating assembly.

16. The vehicle seating assembly of claim 13, wherein the foam assembly is configured to elastically deform from a first configuration to a second configuration, wherein in the second configuration the foam assembly is adapted to cradle an occupant of the vehicle seating assembly.

17. The vehicle seating assembly of claim 13, wherein the vehicle seating assembly is configured to deform under an exerted force to translate an occupant of the vehicle seating assembly towards the gap formed by the seatback frame.

18. A vehicle seating assembly, comprising
a seatback frame; and
a foam assembly coupled with the seatback frame, comprising:
an inboard bolster portion formed of a first inboard portion and a second inboard portion;
an outboard bolster portion formed of a first outboard portion and a second outboard portion;
an upper portion extending between the outboard bolster portion and the inboard bolster portion; and
a torso portion partially circumscribed by the outboard bolster portion, the inboard bolster portion, and the upper portion, wherein the foam assembly is configured to elastically deform from a first configuration to a second configuration, wherein in the second configuration the foam assembly is adapted to cradle an occupant of the vehicle seating assembly.

19. The vehicle seating assembly of claim 18, wherein the first inboard portion is configured to translate towards the seatback frame and the second inboard portion is configured to translate towards the outboard bolster portion, wherein the first inboard portion is configured to translate prior to the second outboard portion as a force is exerted against the vehicle seating assembly.

20. The vehicle seating assembly of claim 18, further comprising a structural wire embedded within the foam assembly, wherein the structural wire extends through a section of an upper portion that is proximal to a rear of a vehicle relative to a headrest aperture formed by the upper portion.
